(19) United States
(12) Patent Application Publication
(10) Pub. No.: US 2004/0006179 A1
(43) Pub. Date: Jan. 8, 2004

(54) Reducing friction of EPDM and related rubbers

(75) Inventor: Hans-Joachim Graf, Stratford (CA)

Correspondence Address: Timothy E. Nauman, Esq., Fay, Sharpe, Fagan, Minnich & McKee, LLP, 1100 Superior Avenue, 7th Floor, Cleveland, OH, 44114-2518, US

(73) Assignee: Cooper Technology Services LLC

(21) Appl. No.: 10/186,758

(22) Filed: Jul. 1, 2002

(51) Int. Cl. C08L 33/04

(52) U.S. Cl. 525/85; 525/331.8; 525/331.7; 525/83; 525/84; 524/474; 524/495

(57) ABSTRACT

A cured elastomeric rubber composition with a reduced coefficient of friction and a relatively high surface energy is disclosed. The composition comprises an elastomeric rubber with polar functional groups grafted to the polymer backbone. The polar functional groups can include amide, amine urethane, ester or silane functional groups. The elastomeric rubber may be any relatively non-polar elastomeric rubber such as EPDM or polyisoprene. Also incorporated into the rubber composition are various rubber additives including for example, carbon black, processing oils, curatives, and clay filler. The incorporation of various functional groups in the rubber compositions effectively reduces the coefficient of friction of the resulting cured rubber component.

### FIELD OF THE INVENTION

The present invention is directed to reduce the coefficient of friction and generally increase the surface tension of elastomeric rubber materials by selecting suitable polar functional groups and employing such functional groups in particular proportions in the manufacture of the rubber materials. The present invention also relates to molded products comprising such materials. The molded elastomeric products of the present invention are particularly adapted for use as seals, weatherstrips and glass run channels for automobiles.

### BACKGROUND OF THE INVENTION

In the automotive industry, many rubber seals are made from EPDM or other types of rubber. These rubbers possess good sealing properties as well as being weather resistant. Unfortunately, untreated EPDM as well as other elastomer rubbers exhibit relatively high coefficients of friction. This increases the amount of squeaks and other noises that can result from the sliding of an automotive door against a door frame seal. In addition, these rubbers tend to have a relatively high surface tension. A high surface tension is undesirable in automotive seals, especially those that are exposed to whether factors such as rain, snow, ice, ultraviolet light, and extreme temperatures. A seal having high surface tension tends to ice over and thus, not readily or effectively perform its sealing function in cold weather.

Thus, a variety of techniques have been proposed for reducing friction of rubber compositions. Surface modifying techniques have been proposed such as treating the surface of a rubber elastomer with fluorine gas (Japanese patent application laid open specification No. 57-80039). Additionally, another proposal involves treating the surface of a rubber elastomer with metallic sodium in liquid ammonia (Japanese patent application laid open specification Nos. 57-56237 and 61-247744). Additionally, Japanese patent application laid open specification No. 61-81437 discloses a method in which a shaped article comprising a vulcanized fluorine-containing rubber is treated with an amine.

Moreover, various surface treating methods have been proposed such as coating surfaces with a fluororesin and exposure to high energy etching techniques. However, for a variety of reasons, including deleterious effects upon other characteristics of the composition, these techniques are not widely used.

The incorporation of internal lubricants has also been proposed. Such lubricants include polytetrafluoroethylene, graphite, molybdenum disulfide, and various oils and reinforcing fibers. However, typical prior art internal lubricants may be costly and increase the complexity and number of processing steps.

The incorporation of various modifiers has also been proposed such as in U.S. Pat. No. 4,174,358, which discloses toughened thermoplastic compositions having a polyamide matrix resin and at least one branched or straight chain toughening polymer.

Additionally, in U.S. Pat. No. 5,039,714, a rubber-modified polystyrene composition containing a polystyrene and dispersed particles of elastomeric polymers is disclosed in combination with at least one or more of mineral oil, and metallic salts or amides of higher fatty acids.

Furthermore, the incorporation of fine, discrete hard particles in a rubber composition has also been investigated. This is noted in U.S. Pat. Nos. 3,685,206 and 4,853,428.

At present, one of the most popular ways for reducing friction on a rubber surface is to apply a coating. Such coatings are applied by activating the surface of the rubber with corona treatment, plasma or gas flame and after treatment applying a primer and finally a topcoat material. This technique is undesirable because it involves several steps and is quite costly. In addition, this technique causes various manufacturing problems. Furthermore, such coatings often fail weather tests and are sensitive to certain window and car cleaner agents. Accordingly, it would be desirable to provide a technique for reducing friction of rubber-based materials and the resulting products created therefrom.

### SUMMARY OF THE INVENTION

The present invention satisfies all of the noted objectives and provides, in a first aspect, a rubber composition exhibiting a reduced coefficient of friction comprising an elastomeric rubber having one or more functional groups and a curing system for the elastomer. The one or more functional groups include amides, amines, urethanes, esters, silanes and combinations thereof.

In another aspect, the present invention provides a low friction rubber composition comprising an elastomeric polymer, 30 to 200 phr of carbon black, 30 to 150 phr of a processing oil, 0.5 to 5 phr of a sulfur source, and 1 to 12 phr of sulfur based cure accelerators. The elastomeric polymer has one or more pendent groups attached along its polymeric backbone, the groups being one or more of maleic anhydride grafted on polyethylene for example, in which the maleic anhydride constitutes about 3.5% by weight of the maleic anhydride grafted polyethylene, butylamine grafted polyacrylate-maleic anhydride copolymer, hexadecylacrylamine, dodecylacrylamine, cyclohexylamine, octylamine, and silane. The proportion of pendent groups ranges from about 1 to about 20% by weight of the polymer.

In yet another aspect, the present invention provides a method for producing a low friction rubber composition comprising the steps of providing an elastomeric polymer, grafting one or more functional groups to the polymer, providing a cure system for the polymer, mixing the polymer with the cure system to form a rubber mixture, and curing that rubber mixture. The functional groups that are groups that are grafted to the elastomeric polymer may include maleic anhydride grafted polyethylene in which the maleic anhydride constitutes about 3.5% by weight of the maleic anhydride grafted polyethylene, butylamine grafted polyacrylate-maleic anhydride copolymer, hexadecylacrylamine, dodecylacrylamine, cyclohexylamine, octylamine, and silane.

### DESCRIPTION OF THE PREFERRED EMBODIMENTS

The present invention relates to the identification of certain modifying agents that when added to rubber compositions, significantly reduce the coefficient of friction of a rubber product made from that composition. This avoids having to perform many of the previously noted operations otherwise necessary to reduce the coefficient of friction of the resulting rubber products. The present invention also relates to particular rubber compositions, rubber-based components produced therefrom, and methods of producing such components. The present invention enables an improved rubber product to be manufactured more economically.

In a preferred embodiment, a technique for reducing friction of elastomeric rubber materials is provided by grafting various functional groups to elastomer polymers. Suitable functional groups include polar functional groups such as amide, amine, urethane and ester groups. Also contemplated for grafting to the elastomer polymer are silane groups. Preferably, the grafted polymers are subsequently crosslinked to form elastomer rubbers. As used herein, “elastomer polymer” or “elastomeric polymer” refers to the base polymer used to make an elastomer without any additives added to the final composition (e.g. fillers, processing oils, etc.). Thus, the various functional groups are preferably grafted to the elastomer polymer prior to mixing the polymer with other rubber components and prior to crosslinking. It will be understood that although the present invention is directed toward rubber or rubber-based polymers (natural and synthetic), compositions containing such, and products made therefrom, the present invention includes modifying the properties of nearly any non-rubber elastomer or elastomeric polymer.

The present invention may be utilized in conjunction with any relatively non-polar peroxide-crosslinkable elastomeric rubber such as various ethylene-propylene rubbers, nitrile rubber, butyl rubber or natural or synthetic rubber. In addition, polyolefinic polymers that are crosslinkable by peroxides such as various thermoplastic polyolefins (TPO's) and thermoplastic elastomers (TPEs) may also be used. A preferred grafting process in accordance with the present invention utilizes polymers having an active radical site (or one that may be readily accessed) on either the polymer backbone or a pendent group. This radical site may be produced via a hydrogen abstraction reaction. The functional groups used in the preferred embodiments described herein may then be grafted to these active radical sites.

A preferred group of compounds are ethylene-a-olefin-diene rubbers (EODM's). The EODM rubbers may comprise various monomers. Suitable α-olefin monomers are designated by the formula CH₂═CHR, where R is a hydrogen or alkyl of 1 to 12 carbon atoms. Suitable α-olefins include, but are not limited to, propylene, 1-butene, 1-pentene, 1-hexene, 1-octene and 1-decene. A preferred α-olefin is polypropylene. Thus, a preferred group of EODM compounds are ethylene-propylene-diene terpolymer (EPDM) rubbers. Suitable dienes include, but are not limited to, nonconjugated dienes such as 1,4-pentadiene, 5-ethylidene-2-norbornene, cyclopentadiene, cyclohexadiene, and 5-butylidene-2-norbornene as well as other straight chain, cyclic and bridged cyclic dienes. A preferred EPDM for use as the elastomer polymer in the preferred embodiments described herein is ethylene-propylene-ethylidene-norbornene terpolymer. EPDM that includes ethylidene-norbornene will be used herein as an exemplary polymer and for convenience in describing various preferred embodiments. As stated previously, however, it is contemplated that other elastomeric polymers may also be used.

Other suitable elastomeric rubber polymers include various diene rubbers such as styrene/butadiene rubber (SBR), nitrile rubber (NBR), natural rubber (NR) and butyl rubber, and polyisobutlyene.

Although the above rubbers can be used in any of various crosslinking states, such as in the state of being noncrosslinked, partially crosslinked or wholly crosslinked in the final rubber composition, it is preferred that the rubber be in a crosslinked state, especially in a wholly crosslinked state (90-100% crosslinked).

The EPDM rubbers are preferably cured using sulfur, a sulfur donor, and/or one or more cure accelerators. However, the present invention includes the use of other cure systems. Examples of suitable sulfur donors and accelerators include, but are not limited to, tetramethylthiuram disulfide (TMTD), dipentamethylenethiuram tetrasulfide (DPTT), 2-mercaptobenzothiazole (MBT), 2-mercaptobenzothiazolate disulfide (MBTS), zinc-2-mercaptobenozothiazolate (ZMBT), zinc diethyldithiocarbamatezinc (ZDEC), zinc dibutyldithiocarbamate (ZDBC), dipentamethylenethiuram tetrasulfide (DPTT), tellurium diethyldithiocarbamate (TDEC), zinc dimethyidithiocarbamate (ZDMC), dithiodimorpholine (DTDM) and N-t-butylbenzothiazole-2-sulfanamide (TBBS). Preferably, sulfur or a sulfur donor is present in an amount of about 0.5 to about 5 parts per hundred parts resin (phr) of the elastomer polymer. The total amount of all accelerators is preferably about 1 to about 12 phr of elastomer polymer.

Any functional group that is readily grafted to an elastomer polymer and that will decrease the friction coefficient of the final rubber is suitable for use in the present invention. These functional groups include polar functional groups such as amide, amine, ester, and urethane. Preferable functional group additive molecules include aliphatic amides, polyacrylate-maleic anhydride reacted with an aliphatic amine, and silane. Preferably, the functional group constitutes from about 1% to about 20% by weight of the entire grafted EPDM polymer.

As described above, a functional group additive containing one or more of the noted functional groups is introduced and grafted to the EPDM polymer. The grafted polymer is then mixed with an appropriate curing agent as well as other components to be incorporated into the final rubber composition and subsequently cured.

Generally suitable polar functional group additive molecules include, but are not limited to, acrylic acid, acrylic acid ethyl ester, acrylic acid butyl ester, methyl methacrylate, N-methylol-acrylimide, N-ethylol-acrylimide (and higher homologues of this class), allyl glycidylether, and maleic anhydride. A specific suitable polar functional group additive is maleic anhydride grafted polyethylene wherein the maleic anhydride constitutes about 3.5% by weight of the maleic anhydride grafted polyethylene. Preferably, the maleic anhydride grafted polyethylene is added to the rubber such that it makes up about 10% by weight of the final rubber composition. Other preferred functional group additives include butylamine grafted polyacrylate-maleic anhydride copolymer, hexadecylacrylamine, dodecylacrylamine, cyclohexylamine and octylamine. Although a separate catalyst may be added to increase the rate of the grafting reaction, such a catalyst is not necessary as the functional group molecules mentioned above will react with already existing residual functional groups on the EPDM.

In addition, the effect of silane functional groups on the friction coefficient of elastomeric rubbers was also investigated. It was found that the addition of silane grafts to the EPDM polymer prior to vulcanization also significantly reduced the coefficient of friction of the resulting elastomeric rubber samples. As stated, the silane preferably constitutes from about 1% to about 20% by weight of the entire grafted EPDM polymer. It was found that this amount of silane provides the best combination of low coefficient of friction and high surface energy in the finished product. Although not wishing to be bound to any particular theory, it is believed that because of its lipophilic properties, silane enriches the surface of the rubber by adhering and immobilizing a layer of fatty molecules on the surface of the EPDM, thereby forming a stable layer against shear stress and resulting in a lower coefficient of friction.

The preferred EPDM rubbers may also include carbon black and processing oil in any concentration that does not adversely affect the properties of the final rubber composition in a significant manner. A typical concentration of carbon black is from about 30 to about 200 phr with a preferred range of about 50 to about 90 phr. A typical concentration of processing oil is from about 30 to about 150 phr.

In addition to the EPDM, the carbon black, the processing oil and the cure system components, the preferred embodiment EPDM rubbers may contain various other ingredients in amounts that do not detract from the desired properties of the resultant composition. These ingredients can include, but are not limited to, activators such as zinc oxide and other metal oxides; fatty acids such as stearic acid and salts thereof; fillers and reinforcers such as calcium or magnesium carbonate, silica, aluminum silicates, and the like; plasticizers and extenders such as dialkyl organic acids, naphthalenic and paraffinic oils and the like; UV stabilizers; antidegradants; softeners; waxes; and pigments.

The uncured EPDM polymer, along with the various curatives, accelerators and other components, are mixed for a temperature and time necessary to obtain a uniform blend or mix. The blends may be accelerated on a mill and cured under typical vulcanization temperatures and time conditions.

In accordance with the present invention, it was surprisingly discovered that the addition or incorporation of the noted functional groups to the EPDM produced a final rubber composition that exhibited a reduced coefficient of friction compared to a similar compound without the functional groups added. The functional groups are preferably in the form of a functional group additive molecule, which is grafted onto the EPDM polymer backbone prior to the mixing of the EPDM with the other rubber components and prior to curing. The resulting grafted EPDM polymer is then introduced into a mixer with the carbon black, processing oil and the other rubber components.

The polar functional groups are typically grafted to the polymer backbone with peroxide using known reaction methods. A reactive extrusion technique for grafting functional groups on polymers may be used, as well as other known techniques. Such techniques are described in U.S. Pat. No. 5,916,974 to Song et al., the complete disclosure of which is incorporated herein by reference. Preferably, an active radical site on either the polymer backbone or its pendent group is formed when peroxide is added to the uncured rubber via a hydrogen abstraction reaction. Instead of permitting two such sites on adjacent polymer molecules to combine to form a crosslink site, the radical formation reaction is carried out in the presence of functional group additive molecules. The grafting molecules are grafted to the polymer chain at these radical sites. As stated above, the resulting grafted polymer is then introduced into a mixer with the other components used to make the finished vulcanized rubber, such as carbon black, processing oil, etc.

Alternately, the functional groups may be introduced into the pre-vulcanized rubber composition without first grafting them to the EPDM. The above-described reaction is then carried out by adding peroxide to the mixer prior to mixing. Although contemplated, this method is not preferred since the various other rubber ingredients may inhibit the grafting reaction.

A particularly preferred composition comprises an elastomeric polymer having disposed along its backbone one or more pendent groups selected from the group consisting of maleic anhydride grafted polyethylene, in which the maleic anhydride constitutes about 3.5% by weight of the maleic anhydride grafted polyethylene, butylamine grafted polyacrylate-maleic anhydride copolymer, hexadecylacrylamine, dodecylacrylamine, cyclohexylamine octylamine, and silane. The pendent groups make up about 1 to about 20% by weight of the grafted polymer. The composition also comprises from about 30 to 200 phr of a carbon black, 30 to 150 phr of a processing oil, 0.5 to 5 phr of a sulfur source, and 1 to 12 phr sulfur cure accelerator.

The rubber composition with grafted EPDM and the various components may be vulcanized by any conventional method. Thus, the rubber composition may be molded into various automotive seals by placing the composition in a heated mold and applying pressure. Vulcanization may also be accomplished under atmospheric pressure in a hot air oven, a combination microwave-hot air oven, or a fluid bed oven. The composition may also be accelerated on a mill to crosslink it and form the desired article.

The crosslinked rubber composition may then be used to make various automotive seals such as glass run channel, belt line seals, cut line seals, etc. The compositions of the present invention find particular usefulness in door belt seals, in which ice is prone to accumulate and which should exhibit a low coefficient of friction to smoothly engage a door edge.

The grafting of the silane to the EPDM follows the same reaction as described above. Platinum catalyst or moisture is used to increase the rate of the reaction and increase the amount of grafting sites.

A particularly preferred process includes the steps of providing an elastomeric polymer, grafting one or more functional groups to the polymer, the functional groups selected from the group consisting of maleic anhydride grafted polyethylene wherein the maleic anhydride constitutes about 3.5% by weight of the maleic anhydride grafted polyethylene, butylamine grafted polyacrylate-maleic anhydride copolymer, hexadecylacrylamine, dodecylacrylamine, cyclohexylamine octylamine, and silane, providing a cure system for the polymer, mixing the polymer with the cure system to form a rubber mixture, and curing the rubber mixture to form the low friction rubber composition.

The resultant rubber compositions find utility in a wide range of applications. In the automobile industry, EPDM rubbers with a generally increased surface tension and a lower coefficient of friction may be molded and used as various seals and glass run channels. The increased surface tension and reduced coefficient of friction prevents doors and windows from sticking to the molded part as well as aiding in ice release and the removal of other debris from the molded rubber part surface.

Experimental

In a first set of trials, various rubber samples were produced containing EPDM grafted with silane or a mixture of polyethylene glycol and methyl methacrylate. In a second set of trials, various other functional groups were grafted to EPDM to form rubber compounds. Testing was performed on compounds from both sets of trials and molded parts made from these compounds were utilized to investigate the effect of the various grafts on the coefficient of friction and surface tension of the rubber samples. Table 1 lists all the ingredients used in the various trials, the identity of the respective compounds or materials, and their manufacturer and/or supplier.

TABLE 1
Summary of Ingredients

| Ingredient | Compound Identity | Supplier |
|---|---|---|
| Vistalon 8600 | EPDM | ExxonMobil |
| PDMS | Polydimethylsiloxane | Dow |
| Lupersol | Diarylperoxide | AKZO-Nobel |
| Sterling 6630 | Carbon Black | Cabot |
| Jetfill 625C | Kaolin clay | Lomas |
| Snowhite 3 | CaCO₃ | Lomas |
| Flexon 815 | Paraffinic oil | Imperial Oil |
| TMTD-67 | Tetramethylthiurame-disulfide | MLPC |
| TDEC-67 | tellurium diethyldithiocarbamate | MLPC |
| MBTS-67 | 2,2′-dithiobisbenzothiazole | MLPC |
| DPTT-67 | Dipentamethylenethiuram tetrasulfide | MLPC |
| ZDMC-67 | zinc dimethyldithiocarbamate | MLPC |
| MBT-80 | 2-mercaptobenzothiazole | MLPC |
| ZDBC-70 | 70% zinc dibutyldithiocarbamate | MLPC |
| Zinc oxide - Activated | Sodium hexamethylene-1 ,6- | Flexsys |
| | bisthiosulfate dihydrate | |
| Pristerene | Stearic acid | Lomas |
| Rhenosorb CG/W | Calcium oxide | RheinChemie |
| Pluriol E4000 | Polyethylene glycol | BASF |
| Zinc oxide-CR4 | Zinc oxide | GHCHEM |
| Adland 8 | Maleic anhydride grafted polyethylene | MLPC |
| | (3.5% MA by weight) | |
| Sulfur-M300-70 | Sulfur | Harwick |

In each of the experimental trials, Vistalon 8600 was used as the base rubber to which the various functional group molecules were grafted. The properties of Vistalon 8600 are listed in table 2.

TABLE 2
Properties of Vistalon 8600

| | |
|---|---|
| Mooney Viscosity, ML (1 + 8) at 125° C. | 81 |
| Ethylene Content (weight %) | 57.5 |
| Ethylene norbornene Content (weight %) | 8.9 |
| Oil Content (Phr) | — |
| Molecular Weight Distribution | Bimodal |

In the first set of trials, various sample parts were produced to measure the effect of different functional groups on the coefficient of friction and surface tension of the finished part. For each sample, additives were grafted to an EPDM polymer. The EPDM was subsequently mixed with conventional rubber additives and cured. The general composition of each sample in the first set of trials is listed in table 3. Concentration values are in parts per hundred resin (phr) of elastomer polymer.

TABLE 3
Composition of Samples in First Trial Set

| Ingredient | Concentration |
|---|---|
| Vistalon 8600 | 100.0 |
| Sterling 6630 | 70.0 |
| Jetfill 625 C | 10.0 |
| Snowhite 3 | 40.0 |
| Zinc oxide CR-4 | 5.0 |
| Pristerene 9429 | 2.0 |
| Pluriol E4000 | 2.0 |
| Flexon 815 | 87.0 |
| Sulfur-M300-70 | 1.8 |
| ZDBC-70 | 1.8 |
| ZDMC-67 | 1.5 |
| MBT-67 | 1.5 |
| TDEC-67 | 0.2 |

As noted, the EPDM component in the above table is grafted Vistalon 8600. Vistalon 8600 is a high diene content EPDM comprising 57.5% by weight ethylene, 8.9% by weight ethylidene norbornene and having a Mooney viscosity of about 81 (ML (1+8) at 125° C.). Thus, in samples 1-3, silane, in the form of polydimethylsiloxane (PDMS), was grafted to Vistalon 8600 using known peroxide grafting reactions. Likewise, for samples 4-7, an equal concentration mixture of polyethylene glycol (PEG) and methyl methacrylate (MMA) was grafted to the EPDM using known peroxide grafting techniques and Luperosol as a peroxide source. Sample 8 was a control sample, in which the EPDM in the above table was conventional ungrafted EPDM. The concentration of the grafting molecules and the EPDM reacted in samples 1-7 is listed in table 4. As stated previously, the concentration of the grafted EPDM in the final rubber compositions was the same as for the ungrafted Vistalon 8600 in the formulation listed in table 3.

TABLE 4
Concentration of Ingredients in Silane and PEG/MMA Samples

| Sample No. | EPDM (g) | silane | PEG/MMA | catalyst |
|---|---|---|---|---|
| 1 | 100.6 | 5.0 | | 5.0 |
| 2 | 100.3 | 5.2 | | 5.0 |
| 3 | 100.1 | 10.1 | | 10.0 |
| 4 | 100.6 | | 1.1 | 0.1 |
| 5 | 100.3 | | 5.2 | 0.1 |
| 6 | 100.2 | | 5.1 | 0.5 |
| 7 | 100.3 | | 5.2 | 0.1 |

The various sample compounds were prepared in a Haacke mixer using a two pass cycle at 60° C. and rolled on a mill. The sample slabs were compression molded and cured at 150° C. for 15 minutes.

The coefficient of friction (COF) of test specimens from each sample was then tested. The COF for each sample was tested using a common motor industry standard, General Motors Engineering Standard GM9891P. In this standard test procedure, strips of molded rubber 15 mm wide and 110 mm long are attached to sleds and pulled at a constant speed of 15 mm/min across a glass surface. Results for the various samples are contained in Table 5.

TABLE 5
Coefficient of Friction of Grafted and Control EPDM Samples

| Sample No. | Mean COF |
|---|---|
| 1 | 3.00 |
| 2 | 2.83 |
| 3 | 2.93 |
| 4 | 3.25 |
| 5 | 1.52 |
| 6 | 1.40 |
| 7 | 2.20 |
| 8 | 3.35 |

As can be seen from the above results, all the grafted samples exhibited improved, lower COF values compared to the ungrafted control sample 8. The majority of the PEG/MMA samples, however, exhibited a significantly lower COF compared to the silane-grafted samples.

The surface tension or surface energy (both synonymous as used herein) of the samples was also measured. To determine surface tension, colored wetting inks of different, defined surface tensions ranging from 30 dyne/cm² to 60 dyne/cm² were sequentially applied to the test specimens, starting with the lowest surface energy ink. When the liquid was observed to be forming droplets after brushed on, the test was repeated with progressively higher surface tension inks until the ink was observed to spread out. The surface tensions of the various samples are listed in Table 6.

TABLE 6
Surface Tension values for Silane and PEG/MMA Samples

| Sample No. | Surface Tension (dyne/cm²) |
|---|---|
| 1 | 30-32 |
| 2 | 30-32 |
| 3 | 34 |
| 4 | 30-32 |
| 5 | 34 |
| 6 | 36 |
| 7 | 34 |
| 8 | 30-32 |

As can be seen from the table, the surface tensions of the various samples are quite similar, regardless of the presence of silane or PEG/MMA grafting. Generally, the presence of PEG/MMA grafting produces a rubber having improved, slightly higher surface tension than a rubber made with silane grafted EPDM or ungrafted EPDM.

In a second set of trials, various other functional groups were added to EPDM rubber to produce additional samples. In these trials, a slightly different composition was utilized to prepare the samples. The composition of the samples used in the second set of trials is listed in table 7. Concentration values are in parts per hundred resin (phr).

TABLE 7
Composition of Samples in Second Trials

| Ingredient | Concentration |
|---|---|
| Vistalon 8600 | 100.0 |
| Sterling 6630 | 75.05 |
| Jetfill 625 C | 27.17 |
| Snowhite 3 | 10.1 |
| Zinc oxide CR-4 | 7.0 |
| Pristerene 9429 | 1.0 |
| Rhenosorb CG/W | 3.8 |
| Pluriol E4000 | 1.9 |
| Flexon 815 | 89.11 |
| Sulfur-M300-70 | 2.3 |
| ZDBC-70 | 2.3 |
| DPTT-67 | 0.87 |
| ZDMC-67 | 2.24 |
| MBT-67 | 1.77 |
| TDEC-67 | 0.34 |

As in the first set of trials, samples were produced in which the Vistalon 8600 of a control compound was replaced with Vistalon 8600 grafted with various functional groups. The rest of the components of the compositions remained the same among all the samples produced. Again, the molecules were grafted to the EPDM using known peroxide catalyzed grafting reactions. The concentration of the grafting molecules and the EPDM reacted in the test samples is listed in table 8. The ungrafted EPDM sample is labeled as “control-2” to distinguish it from the control sample in the first set of trials.

TABLE 8
Concentration of EPDM and Grafting Molecules in Second Trials

| Sample No. | Identity and Amount of Grafting Molecule |
|---|---|
| Control-2 | None |
| 9 | 3% Hexadecylacrylamine |
| 10 | 2% Dodecylacrylamine |
| 11 | 4% Hexadecylacrylamine |
| 12 | 10% Adland 8 |
| 13 | 10% Adland 8 |
| 14 | 10% Adland 8 and 10% B₄NH₄ |
| 15 | 10% Adland 8 and 10% hexadecylacrylamine |
| 16 | 10% Adland 8 and 10% cyclohexylamine |
| 17 | 10% Adland 8 and 10% octylamine |
| 18 | 10% Adland 8 and 10% Hexadecylamine |

As in the first set of trials, the rubber samples were mixed in a Haake mixer and according to the process outlined above. The COF of the samples were cured then measured according to the GM9891P specification. The results for each sample are listed in table 9.

TABLE 9
Coefficient of Friction of Samples 9-18

| | |
|---|---|
| Sample No. | Mean COF |

| | |
|---|---|
| Control-2 | 1.79 |
| 9 | 1.0 |
| 10 | 1.69 |
| 11 | 1.43 |
| 12 | 1.35 |
| 13 | 1.45 |
| 14 | 1.57 |
| 15 | 1.16 |
| 16 | 1.22 |
| 17 | 1.34 |
| 18 | 2.4 |

In addition, the surface tension of the various samples were tested according to the same method as described above. The results are listed in table 10.

TABLE 10
Surface Tension of Samples 9-18

| Sample No. | Surface Tension (dyne/cm²) |
|---|---|
| Control-2 | 30-32 |
| 9 | 38 |
| 10 | 36 |
| 11 | 39 |
| 12 | 34 |
| 13 | 34 |
| 14 | 34 |
| 15 | 34 |
| 16 | 34 |
| 17 | 34 |
| 18 | 34 |

As can be seen from the above tables, samples 9, 10 and 11 provide the best combination of low coefficient of friction and high surface tension compared to the rubber containing the ungrafted EPDM.

As stated, the cured elastomer rubber compositions of the present invention may be used, in addition to other applications, to fashion molded and extruded rubber parts for the motor vehicle industry. The rubber compositions of the present invention may be used to make a variety of parts, including glass run channels, gaskets, hoses, weatherstrips and various seals.

One particularly useful application for the rubber compositions of the present invention is in the manufacture of door seals, such as those described in U.S. Pat. No. 5,411,785, the complete disclosure of which is incorporated herein by reference. A low coefficient of friction, high surface tension door seal will discourage ice and water from sticking to the seal as well as enable other door parts to slide easily against the seal. Such a door seal will typically have a longitudinally extending main body member. In addition, the door seal will preferably have at least one sealing lip to engage and seal against a vehicle body panel and at least one retention spur to hold the door seal securely in a vehicle door frame.

The foregoing description is, at present, directed to the preferred embodiments of the present invention. However, it is contemplated that various changes and modifications apparent to those skilled in the art may be made without departing from the present invention. Therefore, the foregoing description is intended to cover all such changes and modifications encompassed within the spirit and scope of the present invention, including all equivalent aspects.

What is claimed is:

1. A polymeric rubber composition exhibiting a reduced coefficient of friction comprising:
an elastomeric rubber polymer including a polymeric backbone and at least one functional group disposed along said polymeric backbone, said functional group selected from the group consisting of amide, amine, urethane, ester, silane, and combinations thereof; and
a curing system in an amount sufficient to crosslink said elastomeric rubber polymer.

2. The rubber composition according to claim 1, further comprising carbon black, and a processing oil.

3. The rubber composition according to claim 2, wherein said carbon black is present in a concentration of about 30 to about 200 phr and said processing oil is present in a concentration of about 30 to about 150 phr.

4. The rubber composition according to claim 1, wherein said curing system comprises sulfur and one or more sulfur cure accelerators.

5. The rubber composition according to claim 4, wherein said curing system comprises sulfur in a concentration of about 0.5 to about 5 phr and sulfur cure accelerators in a concentration of about 1 to about 12 phr.

6. The rubber composition according to claim 5, wherein said curing system comprises 2-mercaptobenzothiazole (MBT), zinc dibutyldithiocarbamate (ZDBC), and tellurium diethyldithiocarbamate (TDEC),

7. The low friction rubber composition according to claim 1, wherein said elastomeric rubber polymer is present in a concentration of about 50 to about 150 phr.

8. The rubber composition according to claim 1, wherein said elastomeric rubber polymer is EPDM.

9. The rubber composition according to claim 1, wherein said functional group comprises hexadecylacrylamine.

10. The rubber composition according to claim 1, wherein said functional groups comprises a polyacrylate-maleic anhydride copolymer grafted with an aliphatic amine.

11. The rubber composition according to claim 10, wherein said aliphatic amine is butylamine.

12. The rubber composition according to claim 10, wherein said functional group comprises maleic anhydride grafted polyethylene wherein said maleic anhydride constitutes about 3.5% by weight of said maleic anhydride grafted polyethylene

13. The rubber composition according to claim 1, wherein said functional group constitutes about 1% to about 10% by weight of said elastomeric rubber polymer.

14. The rubber composition according to claim 12, wherein said functional group constitutes about 5% by weight of said elastomeric rubber composition.

15. An automobile seal made from the rubber composition according to claim 1.

16. A low friction rubber composition comprising:
an elastomeric polymer having disposed along its backbone one or more pendent groups selected from the group consisting of (i) maleic anhydride grafted polyethylene, wherein the maleic anhydride constitutes about 3.5% by weight of the maleic anhydride grafted polyethylene, (ii) butylamine grafted polyacrylate-maleic anhydride copolymer, (iii) hexadecylacrylamine, (iv) dodecylacrylamine, (v) cyclohexylamine octylamine, (vi) silane, and (vii) combinations thereof; wherein said pendent groups constitute about 1 to about 20% by weight of the grafted polymer;
to 200 phr of a carbon black;
to 150 phr of a processing oil;
0.5 to 5 phr of a sulfur source; and
1 to 12 phr sulfur cure accelerator.

17. An automobile seal made from the composition according to claim 16.

18. A method for producing a low friction rubber composition, the method comprising the steps of:
providing an elastomeric polymer;
grafting one or more functional groups to said polymer to form a grafted polymer, said functional groups selected from the group consisting of (i) maleic anhydride grafted polyethylene, wherein the maleic anhydride constitutes about 3.5% by weight of the maleic anhydride grafted polyethylene, (ii) butylamine grafted polyacrylate-maleic anhydride copolymer, (iii) hexadecylacrylamine, (iv) dodecylacrylamine, (v) cyclohexylamine octylamine, (vi) silane, and (vii) combinations thereof;
providing a cure system for said grafted polymer;
mixing said grafted polymer with said cure system to form a rubber mixture; and
curing said rubber mixture to form said low friction rubber composition.

19. The method according to claim 18, wherein the step of providing an elastomeric polymer is performed by providing an EPDM polymer.

20. The method according to claim 18, further comprising a step of mixing carbon black and a processing oil with said grafted polymer.

21. The method according to claim 18, wherein the step of providing said cure system is performed by providing sulfur and one or more sulfur accelerators.

22. The method according to claim 18, wherein the step of grafting one or more functional groups to said polymer is performed using a peroxide catalyzed reaction.
